(19) United States
(12) Patent Application Publication
(10) Pub. No.: US 2026/0099488 A1
(43) Pub. Date: Apr. 9, 2026

(54) NATURAL LANGUAGE QUERY PROCESSING USING LARGE LANGUAGE MODEL-BASED ASSET ANALYSIS

(71) Applicant: International Business Machines Corporation, Armonk, NY (US)

(72) Inventors: Joshua Abraham, Thornhill (CA); Kun Lu, Whitby (CA); Yuhan Shao, Toronto (CA); Zhibo Zhang, Ottawa (CA); Hosam Aly, Kanata (CA)

(21) Appl. No.: 18/905,787

(22) Filed: Oct. 3, 2024

(51) Int. Cl. G06F 16/2452; G06F 16/242; G06F 40/247; G06F 40/279

(52) U.S. Cl. CPC G06F 16/24522; G06F 16/2423; G06F 40/247; G06F 40/279

(57) ABSTRACT

A present invention embodiment processes user queries. Using a large language model (LLM), a first Structured Query Language (SQL) statement is generated based on a user query provided by a user. A plurality of entities are extracted, based on the first SQL statement, including columns, filter columns, and categorical filters. A semantic search is performed on an index of a plurality of databases using the extracted entities to determine a confidence score for each database of the plurality of databases. A database is selected based on the confidence score and a schema of the selected database is extracted. A second SQL statement is generated by the LLM based on the user query and the schema. The second SQL statement is executed on the selected database to generate query results that are presented to the user.

### BACKGROUND

### 1. Technical Field

Present invention embodiments relate to natural language query processing, and more specifically, to processing natural language queries using a large language model to analyze and query databases.

### 2. Discussion of the Related Art

In the field of natural language processing, a user's natural language query can be processed to generate a response. For some queries, a structured database may contain data that is relevant to answering a user's query. However, without an indication of which database to consult, identifying structured data that can answer a user's query can be difficult.

### SUMMARY

According to one embodiment of the present invention, a system is provided for processing user queries. Using a large language model (LLM), a first Structured Query Language (SQL) statement is generated based on a user query provided by a user. A plurality of entities are extracted, based on the first SQL statement, comprising one or more columns, filter columns, and categorical filters. A semantic search is performed on an index of a plurality of databases using the one or more columns, filter columns, and categorical filters to determine a confidence score for each database of the plurality of databases, wherein the confidence score indicates a match for each database with respect to the one or more extracted columns, filter columns, and categorical filters. A database is selected based on the confidence score and extracting a schema of the selected database. Using the LLM, a second SQL statement is generated based on the user query and the schema. The second SQL statement is executed on the selected database to generate query results. The query results are presented to the user. Embodiments of the present invention further include a method and computer program product for processing user queries in substantially the same manner described above.

Various other embodiments of the present invention will now be discussed. The various embodiments can be optional, and should not be construed as necessary to practice any aspects of embodiments presented herein.

In some embodiments, the selected database is validated using an LLM by providing, to the LLM, a prompt that includes the user query, the schema of the selected database, and a request to determine that the selected database includes data that supports the user query. By validating a database, the embodiments presented herein ensure that the database can support the user query, thus reducing processing requirements by avoiding query execution on a database that would not provide relevant results for the user query.

The candidate databases may be ranked using a confidence score that indicates a match for each candidate database with respect to entities (e.g., columns, filter columns, and/or categorical filters) that are extracted from the database query that is initially generated by an LLM based on the user query. In some embodiments, the confidence score is determined by evaluating column names of each database with respect to the one or more extracted columns or filter columns. By determining that column names in candidate databases are relevant to a user query, the accuracy of results is improved.

In some embodiments, the confidence score is determined by generating synonyms of one or more extracted columns or filter columns, and evaluating column names of each database with respect to the generated synonyms. By using synonyms, additional relevant databases can be identified, thereby increasing the pool of candidate databases and improving the accuracy of query processing as a result.

In some embodiments, the confidence score is determined by evaluating one or more extracted categorical filters with respect to categorical filters of each database. By analyzing databases with respect to categorical filters, present invention embodiments ensure that the databases contain the type of data that is relevant to a user query, thus improving the accuracy of the results that are presented to a user.

In some embodiments, a prompt is provided to the LLM to generate an SQL statement that includes one or more examples of desired output. A one-shot prompt or many-shot prompt improves the output of an LLM, thereby generating more accurate database queries which improve the analysis of candidate databases as well as the processing of selected databases.

In some embodiments, a prompt is provided to the LLM to generate an SQL statement that complies with a particular SQL dialect. This improves the accuracy of database query processing by ensuring that the SQL statement matches the dialect of the selected database.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of query processing code according to an embodiment of the present invention.

FIG. 3 is a flow diagram of a process for analyzing databases and generating database queries according to an embodiment of the present invention.

FIG. 4 is a flowchart of a method for executing user queries according to an embodiment of the present invention.

### DETAILED DESCRIPTION

A present invention embodiment relates to natural language query processing, and more specifically, to processing natural language queries using a large language model to analyze and query databases. In the fields of natural language processing (NLP) and machine learning (ML), a user can submit natural language queries for processing by an NLP/ML model. For example, if a user wants to find information about top-selling products in different cities, the user may submit a query such as “what is the best-selling product in major cities across the United States?”. In order to respond to such a query, a relational database may be searched in order to identify results. However, without an indication of which particular database to search, it may not be possible to accurately locate the structured data that is relevant to answering a user's question.

The embodiments presented herein address this problem by employing a multi-stage approach in which a specific database is first identified for use in responding to a user query, and a database query is automatically generated for querying the specific database to obtain results that can be used to answer the user query. Specifically, a large language model is employed to generate a database query based on a user query. The database query can be in the form of any standardized language, such as the Standard Query Language (SQL). Next, entities included the database query can be extracted and used to identify a relevant database for use in responding to the user query. In particular, the entities may include columns, filter columns, and/or categorical filters. These entities can be used to perform a semantic search using a search engine that indexes a plurality of databases in which each database is scored with respect to that database's relevance toward the user query. When a relevant database is identified, the schema of the relevant database(s) can be used by the large language model to generate a refined database query. This query can then be executed against the relevant database(s) in order to generate a response to the user query.

Thus, present invention embodiments provide a novel approach to natural language processing in which a generative machine learning model generates database queries to identify particular databases of interest to user queries and to then utilize the identified database to generate responses to the user queries. By employing a unique data structure that indexes various databases, the embodiments presented herein enable databases to be quickly ranked with regard to relevance to a user query, thereby identifying and querying the most relevant database(s). Accordingly, present invention embodiments improve the fields of natural language processing and query processing by employing focused searches that only query relevant databases. This approach reduces processing, memory, and network resources by leveraging queries in a manner that fetches only the relevant data. Moreover, the use of an index for database selection further reduces computing resource requirements, as the underlying databases do not need to be accessed until a database is determined to be relevant. Thus, present embodiments provide the practical application of improving the relevance and accuracy of NLP/ML-generated responses to user queries.

In some embodiments, the selected database is validated using an LLM by providing, to the LLM, a prompt that includes the user query, the schema of the selected database, and a request to determine that the selected database includes data that supports the user query. By validating a database, the embodiments presented herein ensure that the database can support the user query, thus reducing processing requirements by avoiding query execution on a database that would not provide relevant results for the user query.

The candidate databases may be ranked using a confidence score that indicates a match for each candidate database with respect to entities (e.g., columns, filter columns, and/or categorical filters) that are extracted from the database query that is initially generated by an LLM based on the user query. In some embodiments, the confidence score is determined by evaluating column names of each database with respect to the one or more extracted columns or filter columns. By determining that column names in candidate databases are relevant to a user query, the accuracy of results is improved.

In some embodiments, the confidence score is determined by generating synonyms of one or more extracted columns or filter columns, and evaluating column names of each database with respect to the generated synonyms. By using synonyms, additional relevant databases can be identified, thereby increasing the pool of candidate databases and improving the accuracy of query processing as a result.

In some embodiments, the confidence score is determined by evaluating one or more extracted categorical filters with respect to categorical filters of each database. By analyzing databases with respect to categorical filters, present invention embodiments ensure that the databases contain the type of data that is relevant to a user query, thus improving the accuracy of the results that are presented to a user.

In some embodiments, a prompt is provided to the LLM to generate an SQL statement that includes one or more examples of desired output. A one-shot prompt or many-shot prompt improves the output of an LLM, thereby generating more accurate database queries which improve the analysis of candidate databases as well as the processing of selected databases.

In some embodiments, a prompt is provided to the LLM to generate an SQL statement that complies with a particular SQL dialect. This improves the accuracy of database query processing by ensuring that the SQL statement matches the dialect of the selected database.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

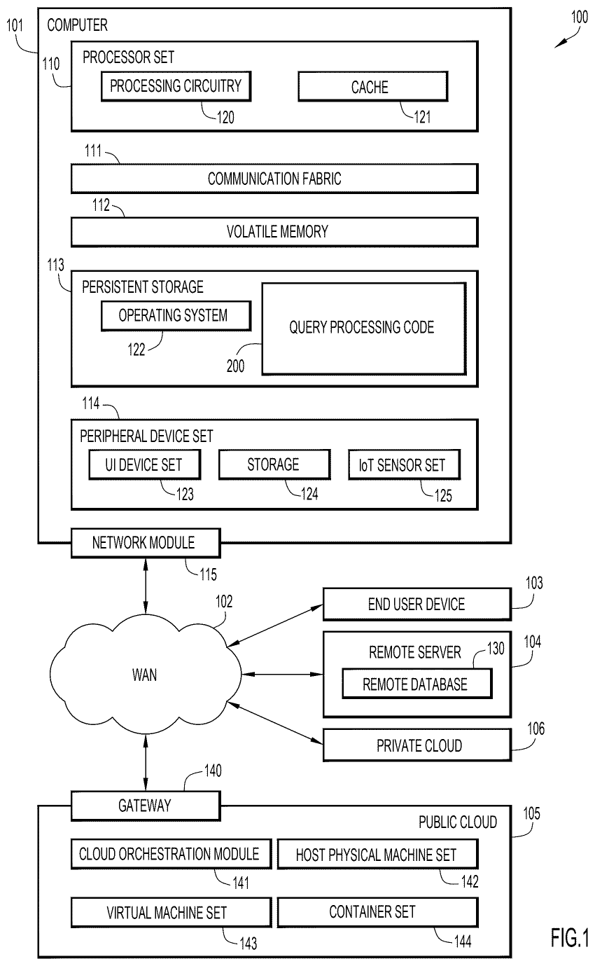

Referring to FIG. 1, computing environment 100 contains an example of an environment for the execution of at least some of the computer code involved in performing the inventive methods, such as query processing code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

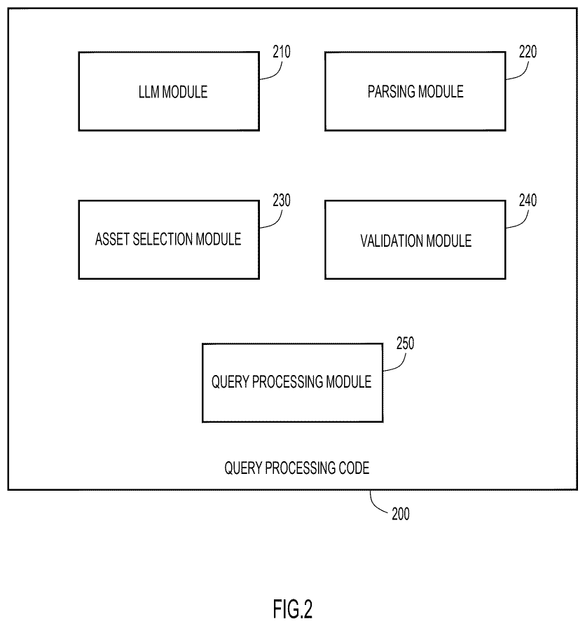

A block diagram of query processing code 200 according to an embodiment of the present invention is illustrated in FIG. 2. Specifically, query processing code 200 includes a large language model (LLM) module 210, a parsing module 220, an asset selection module 230, a validation module 240, and a query processing module 250. LLM module 210, parsing module 220, asset selection module 230, validation module 240, and query processing module 250 may include one or more modules or units to perform various functions of present invention embodiments described herein. LLM module 210, parsing module 220, asset selection module 230, validation module 240, and query processing module 250 may be implemented by any combination of any quantity of software and/or hardware modules or units, and may reside within volatile memory 112 of computer 101 for execution by a processor, such as processor set 110.

LLM module 210 may utilize one or more trained machine learning models to perform generative tasks in accordance with the embodiments presented herein, including generating database queries such as SQL statements. LLM module 210 may include one or more trained machine learning models, such as a large language model having a large number of weights (e.g., twenty billion or more). In various embodiments, LLM module 210 may include a local model, or LLM module 210 may access a model that is hosted in a network-accessible location. For example, LLM module 210 may serve as an Application Programming Interface (API) for an LLM. The LLM employed by LLM module 210 may be a general model or may be fine-tuned on database query (e.g., SQL statement) generation. Fine-tuning the LLM may include additional training using training data that includes examples of natural language user queries and corresponding SQL statements.

In general, LLM module 210 may receive natural language user queries as input and may generate database queries (e.g., SQL statements) as output based on the user queries. LLM module 210 may be provided with a prompt that includes a user query and a request to generate an SQL statement based on the user query. An SQL statement generated by LLM module 210 may include one or more columns, filter columns, and/or categorical filters. In particular, columns may indicate a name of columns to search, whereas filter columns may include additional filters imposed upon any data fetched from those columns. For example, in the SQL statement “SELECT name, age FROM users WHERE age>18”, “name” and “age” are columns that are selected from the table “users”, and “age>18” is a filter column that applies an instruction that rows should only be returned if the user's age is greater than 18. Categorical filters are also filter conditions of a WHERE clause in which the data adheres to specific limited categories, such as marital status (e.g., “married” vs. “single”). For example, the SQL statement “SELECT*FROM products WHERE category IN (‘Electronics’, ‘Clothing’)” includes the categorical filters of “electronics” and “clothing”, and instructs rows to be selected from the table “products” only if a the “category” column of a row includes the entry of “electronics” or “clothing”. As another example, LLM module 210 may receive as input a natural language user query comprising “display the highest-selling products in Toronto where the store's revenue exceeds $10,000”, and may generate an SQL statement that includes the columns of “sales” and “products”, the filter column of “revenue”, and the categorical filter of “Toronto”.

In some embodiments, LLM module 210 may be provided with one or more examples of desired output in a prompt. For example, the LLM may be provided with two examples of output (e.g., a two-shot prompt). In some embodiments, a prompt provided to the LLM may include a request that an SQL statement generated by the LLM conform to a particular SQL dialect (e.g., MySQL). In some embodiments, the prompt may include a request that the LLM use as few sub-queries as possible, especially with respect to the WHERE clause, which reduces the processing requirements for column and filter column extraction during parsing. In some embodiments, the prompt includes an instruction for the LLM to avoid performing mathematical calculations in the generated SQL statement, which may provide the benefit of reducing hallucinations. In some embodiments, the prompt may include instructions for the LLM to perform a chain-of-thought analysis in which the process of generating an SQL statement is broken down into steps upon which the LLM is instructed to process independently.

Parsing module 220 may include a parsing package that can convert a database query into an abstract syntax tree (AST). In particular, parsing module 220 can convert an SQL statement into an AST, which is a machine-readable format that enables the database query to be executed upon a database. Parsing module 220 thus transforms and improves a query for faster execution by structuring the query into logical steps that can be executed in an optimal order. By parsing a query, complex queries that include subqueries or nested logic can also be simplified, thus reducing processing requirements. An AST that is generated by parsing module 220 may be analyzed to extract the columns, filter columns, and/or categorical filters, which can be provided to asset selection module 230.

Asset selection module 230 may perform semantic searching operations in order to rank and identify databases that are relevant to a user query. Each database may be local (e.g., stored on computer 101) or remote (e.g., remote database 130 of remote server 104), and the databases may exist across any number of storage devices in various network-accessible locations. Asset selection module 230 may analyze one or more indexes that contain relevant data about a plurality of databases. The indexes can be populated with data that is obtained from a web crawler that discovers databases on the Internet and obtains the relevant data. In some embodiments, an index is provided that contains column names of a plurality of databases. Additionally or alternatively, an index can be provided that contains unique categorical values sampled from each column of a plurality of databases. The column index and/or categorical value index can be used by asset selection module 230 in combination with the columns, filter columns, and/or categorical filters provided by parsing module 220 in order to perform a semantic search of the databases.

Asset selection module 230 may perform various semantic search techniques in order to generate confidence scores for each database, with each confidence score indicating the likelihood that a particular database contains data that can support execution of a database query that is generated based on a natural language user query in accordance with the embodiments described herein. Thus, asset selection module 230 can identify which databases are relevant to a user query. Since no database is indicated in the user query, the schema of the database that is ultimately selected is unknown; therefore, asset selection module 230 performs semantic searches that identify database columns and/or categorical filters that most closely match the columns and/or categorical filters obtained by processing the user query with an LLM.

In some embodiments, assert selection module 230 uses the extracted column and filter column names to perform a semantic search. The semantic search can compare the extracted column and/or filter column names to entries in the column index to compute a match score for each column and/or filter column. This process may include direct matching, fuzzy matching (e.g., stemming, lemmatization, etc.), and the like. The degree to which each database's column names in the column index match the extracted column and/or filter column names can thus be used to compute an overall match score for each database. For example, a database having a higher number of matches and/or closer matches (e.g., direct matches rather than fuzzy matches) may have a score that indicates that the database is more relevant compared to other databases having fewer matches and/or less-close matches.

In some embodiments, an LLM can be used to perform semantic searching. The LLM may correspond to an LLM employed by LLM module 210 or a different LLM. In some embodiments, the LLM includes a general-purpose generative model. The LLM may generate synonyms for each input word (e.g., column name, filter column name) and the synonyms can then be used to search the column index similarly to how the direct and/or fuzzy matching is performed.

In some embodiments, semantic searching is performed for each categorical filter value. Using the categorical filter index, match scores may be computed for each extracted categorical filter to identify databases whose categorical filters match the extracted categorical filters. This score can indicate the degree to which a database includes relevant categorical filters, and the value of a score can depend on the number of matches, the closeness of matches (e.g., direct, fuzzy, and/or synonym matches), and the like.

In some embodiments, the results of various semantic searches are combined to determine an overall confidence score for each database. In particular, the sub-scores obtained from (i) the column and/or filter column matching, (ii) the LLM synonym search, and (iii) the categorical filter search can be combined to obtain the overall confidence score for each database. In various embodiments, the sub-scores can be averaged, summed, or otherwise combined using any statistical or mathematical techniques. In some embodiments, different weights are applied to each sub-score. For example, the column and/or filter column matching sub-score may receive a heavier weight than the LLM synonym matching sub-score, which may in turn receive a higher weight than the categorical filter search sub-score. Thus, different sub-scores can have different levels of influence over the resulting overall confidence score.

In some embodiments, when multiple search results from the same database map to a same extracted column name, only the top scoring result may be maintained. For example, if the extracted column name “Products” maps to both “Products” and “ProductSize” in a database, only the mapping to “Products” will be used as it is a direct match and thus would be assigned a higher score.

Once the confidence scores are determined for each database, asset selection module 230 can sort the databases and select one or more relevant databases for use in executing a database query. In some embodiments, databases are sorted by the overall confidence score, and the most relevant database is selected as indicated by its confidence score value. In other embodiments, other considerations are included, such as the number of mapped columns, number of mapped categorical filters, and the like. In one embodiment, databases are sorted by the number of columns that were found to match the extracted column names. For example, if three column names were extracted, but only two were found to match in a particular database, that database would be sorted lower than another database in which all three extracted column names appear. The databases can then be sorted by the number of categorical filter matches, and then sorted by the number of exact column name vs. synonym matches. The databases may then be sorted by confidence score. As a result, asset selection module 230 generates a ranked list of databases sorted by each database's ability to answer a user query. A number of the highest-ranked databases may then be selected for additional processing (e.g., validation, query processing, etc.). In some embodiments, a top-ranked database is selected, whereas in other embodiments, a top percentage of databases (e.g., top 10% of databases) or a fixed number of top databases (e.g., top five) are selected.

Validation module 240 may perform operations to evaluate selected databases with regard to whether each database can support a database query that would be relevant to a user query. In some embodiments, validation module 240 utilizes an LLM for validation tasks, which may be the same LLM as utilized by LLM module 210 or a different LLM (e.g., a general-purpose LLM). Validation module 240 may provide a prompt to the LLM that includes the user query and the database schema of the database being validated. The schema can be in any format (e.g., JavaScript® Object Notation (JSON), etc.), and may include column names, column descriptions, and data types of each column. The prompt may additionally include a request to compare the schema to the user query to evaluate whether or not the database includes all necessary columns for answering the user query. Thus, only validated databases may be used to execute the database query, thereby avoiding the unnecessary expenditure of computing resources.

Once a database is selected and validated, a database query can be generated using the user query and the schema for the database being queried (which is now known as a particular database has been selected). LLM module 210 may generate the database query using an LLM that is prompted to generate a complete query against the given database schema to answer the user query, which is included in the prompt. The LLM may specifically be prompted to generate an SQL statement, and may further be requested to generate an SQL statement that complies with a specific SQL dialect (e.g., MySQL). In some embodiments, the prompt may include a number of examples (e.g., a ten-shot prompt) of desired output. Further, the prompt may instruct the LLM to discard all specific schemas and queries used in the examples provided in the prompt, which improves the generalization capability and accuracy of output. In some embodiments, the LLM is prompted to use as few sub-queries as possible, which reduces the processing requirements for parsing the resulting SQL statements. The model can also be prompted to reduce hallucinations when generating filters.

Query processing module 250 may execute database queries that are generated by the LLM using the user query in combination with the schema of the database being queried. Initially, an SQL statement may be parsed by parsing module 220 to generate an AST, which may then be executed by query processing module 250 on the selected database. In some embodiments, columns, filter columns, categorical filters, modifiers, aggregates, and/or other entities may be extracted from the AST for use in translating the SQL statement to other query specifications, depending on the query language supported by the underlying database. Once the database query results are obtained, query processing module 250 can provide the results as a response to the user query. In some embodiments, the results may be provided to an LLM, which can be prompted with the user query and the results, as well as a request to generate a response to the user query. This natural language response may then be provided to a user device as the answer to the user query.

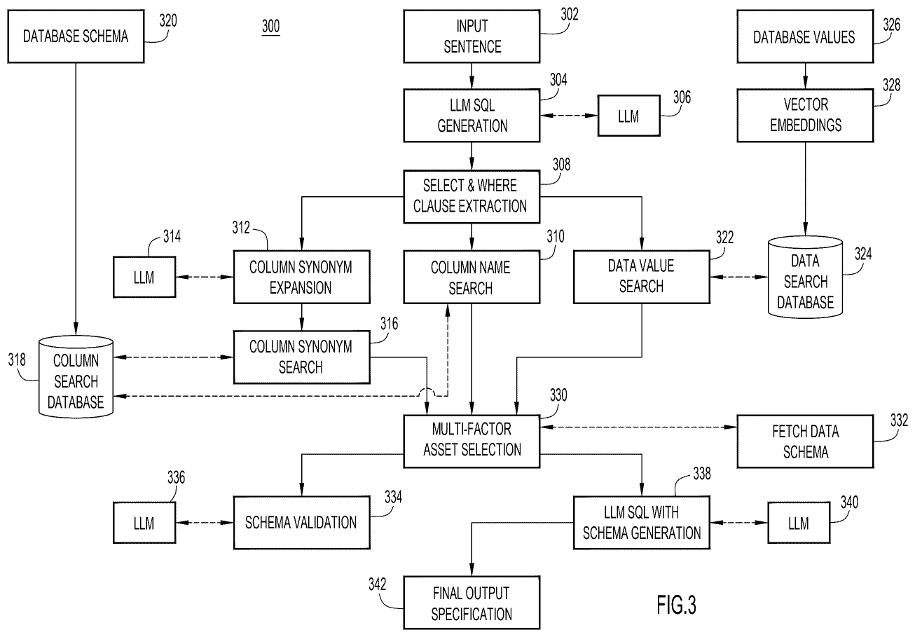

With reference now to FIG. 3, a flow diagram is provided of a process 300 for analyzing databases and generating database queries according to an embodiment of the present invention. Initially, an input sentence 302 (i.e., a user query) is received. The input sentence 302 is processed to perform LLM SQL generation at operation 304 using an LLM 306 (it should be appreciated that each LLM depicted in process 300 may be a same LLM or a different LLM). The LLM 306 may be prompted to generate a SQL statement based on the input sentence; the prompt may include other instructions to improve processing and accuracy, such as instructions to use a particular SQL dialect, instructions to use as few sub-queries as possible, and instructions to generate output similar to provided examples of desired output in the prompt.

At operation 308, the SELECT and WHERE clause entities are extracted from the resulting SQL statement, which may be parsed into an AST prior to extraction. The extracted entities may include column names, filter columns, and/or categorical filters. These entities may be used to analyze a search index containing reference to a plurality of database that is populated with corresponding entities from each database. Column name searching is performed at operation 310, which includes identifying databases, via the index, that have columns whose names are direct or fuzzy matches to extracted column names. A column search database 318 may be accessed, which includes the index that is generated based on the database schema 320 of each indexed database.

Column synonym expansion is performed at operation 312 using an LLM 314. The LLM may be prompted to generate synonyms for column names that are extracted at operation 308; these synonyms may be used to perform a column synonym search at operation 316. The column synonym search may use column synonyms to search similarly to how column names are utilized at operation 310. In particular, the column search database 318 is accessed to use the column name index for matching.

At operation 332, a data value search is performed to identify categorical filters that correspond to the entities extracted at operation 308. A data search database 324 may include an index of unique categorical filters for each database that is indexed. This index can be populated by analyzing database values 326 to identify unique entries in columns. In some embodiments, vector embeddings 328 may be obtained for each unique entry for comparison to a vector embedding of an extracted entity in order to identify similar categorical filters in a vector space model using a similarity measure such as cosine similarity.

At operation 330, multi-factor asset selection is performed using the results of operation 310, 312, and 322. In particular, databases may be sorted based on the degree of matching of column names, column filters, and/or categorical filters for each database with respect to the entities extracted at operation 308. The degree of matching of extracted entities to database entities can be computed to provide a confidence score for each database, which can be a value based on the various matches that are identified in each database. The different types of matches, and degrees thereof, can each influence the confidence score and can be separately weighted such that some types and/or degrees of matches more greatly influence the resulting confidence score as compared to others.

Once the databases are ranked, one or more databases can be selected for further processing. In particular, a most relevant one or more databases may be selected; for each database, the corresponding schema may be fetched at operation 332.

At operation 334, the schema of a selected database is validated to determine whether the database can support execution of a database query based on the user query. The schema can be validated with an LLM 336 by providing the user query and schema to the LLM in a prompt that requests the LLM to determine whether the database includes data that can be used to respond to the user query. Schema validation may be performed in parallel with execution of a database query in order to reduce computational time requirements. When a database is selected, the query is executed against the selected database. In addition, a secondary LLM call can be run in parallel to validate whether the selected schema can answer the user query, reducing the likelihood of hallucinations. However, when a selected database is determined to not support the user query, a next highest-ranked database may be selected for validation and processing based on the ranking of the databases.

At operation 338, an LLM 340 is used to generate a SQL statement using the schema of the selected database. The LLM 340 may be prompted with the user query and schema details, along with other instructions, such as to generate a SQL statement in a particular SQL dialect, to generate a SQL statement using as few sub-queries as possible, and the like. In some embodiments, a few-shot prompt will be provided to the LLM 340 in which one or more examples of desired output are included. In some embodiments, a timestamp corresponding to a timer of the user query is also provided to the LLM in order to ensure that the database query searches for currently-relevant data.

At operation 342, a final output specification is generated. This specification may include an executable AST that is generated by parsing the output of the LLM 340. The output specification can then be executed on the selected validated database to generate a response to the user query, which may then be provided to the user. In some embodiments, the results of query execution may be provided to an LLM in order to generate a natural language response to the user query.

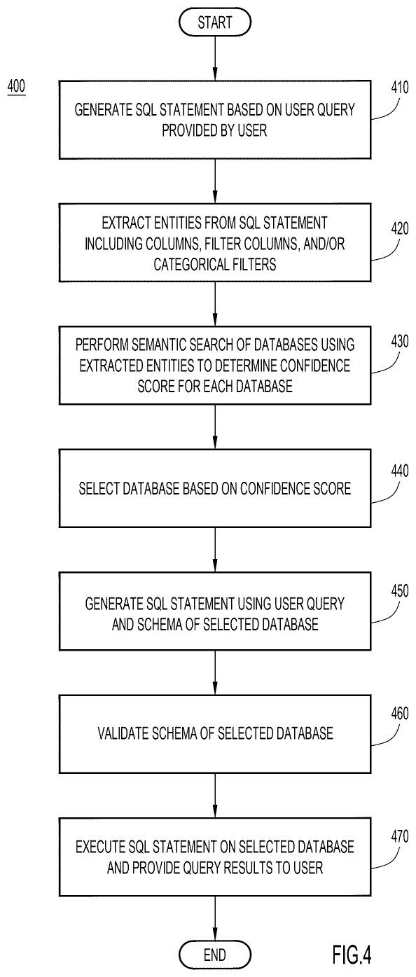

FIG. 4 is a flowchart of a method 400 for executing user queries according to an embodiment of the present invention.

An SQL statement is generated based on a user query provided by a user at operation 410. The user query may include a natural language question, which is provided to an LLM in a prompt that also request for an SQL statement to be generated based on the query. The prompt may include other details, such as examples of desired output (i.e., a one-shot prompt or many-shot prompt), a request to generate output that includes as few sub-queries as possible, a request that the output conform to a particular SQL dialect, and the like.

Entities are extracted from the SQL statement that include one or more columns, filter columns, and/or categorical filters at operation 420. Initially, the SQL statement may be parsed to generate an AST from which the entities are extracted. However, in other embodiments, the entities may be directly extracted from the SQL statement. The entities can include one or more column names, filter columns, and categorical filters.

A semantic search of databases is performed using the extracted entities to determine a confidence score for each database at operation 430. In some embodiments, the column names and/or filter columns are evaluated with respect to column names in each database to identify direct and/or fuzzy matches, the number and/or closeness of which influences the confidence score. In some embodiments, an LLM is employed to generate synonyms of column names and/or filter columns, which are then similarly evaluated with respect to column names in each database. In some embodiments, categorical filters are compared to unique categories of data entries in each database to determine the confidence score for each database. The various approaches to determining confidence scores can be combined in any manner in order to obtain confidence scores for each database.

A database is selected base on the confidence score of the database at operation 440. The databases can be ranked by confidence score and one or more databases can be selected based on their confidence score indicating that the selected databases are most likely to support execution of an SQL statement that corresponds to the user query. In some embodiments, the databases may be evaluated using an LLM to validate whether or not each selected database may support the user query.

An SQL statement is generated using the user query and schema of the selected database at operation 450. Once a database is selected (and optionally validated), the database schema is known and can be provided to an LLM along with the user query and a request to generate an SQL statement that is specific to the database's schema. Similarly to the initial SQL statement that is generated, the LLM can be prompted with additional instructions to refine the output.

The schema of the selected database is validated at operation 460. In particular, a prompt may be provided to an LLM that includes the user query, the schema of the selected database, and a request to determine whether the selected database can support execution of an SQL statement that would obtain the relevant data for responding to the user query. If the LLM returns an answer that the database can support such a query, then the database may be utilized. However, if the LLM returns an answer that the database cannot support a query, then another database may be selected for validation (e.g., a next highest-ranked database).

The SQL statement is executed on the selected database, and query results are provided to the user at operation 470. The SQL statement may be parsed to generate an AST that can be executed on the selected database to return the query results. In some embodiments, the query results may be provided to an LLM in order to generate a natural language output as a response to the user query.

It will be appreciated that the embodiments described above and illustrated in the drawings represent only a few of the many ways of implementing embodiments for automatically executing user queries using LLMs and semantic searching to identify relevant databases.

The environment of the present invention embodiments may include any number of computer or other processing systems (e.g., any computing device, treatment delivery device, computing service, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., LLM module 210, parsing module 220, asset selection module 230, validation module 240, query processing module 250, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, distributed computing, and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the computing system. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., database queries, SQL statements, ASTs, column names, filter columns, categorical filters, database contents, database schemas, indexes, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

User query data, database query data, SQL statement data, AST data, column name data, filter column data, categorical filter data, database contents, database schema data, and/or index data, may include any information arranged in any fashion, and may be configurable based on rules or other criteria to provide desired information to a user.

The present invention embodiments are not limited to the specific tasks or algorithms described above, but may be utilized for answering any user questions in the absence of a user indication of a particular database to utilize for said questions.

The data may include any format of storing data and may include any data descriptive of databases, including metadata and indexes thereof. The data may be obtained via any techniques, and may be accessed over a network, fetched from local storage, provided via user input, and the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
generating, using a large language model (LLM), a first Structured Query Language (SQL) statement based on a user query provided by a user;
extracting a plurality of entities, based on the first SQL statement, comprising one or more columns, filter columns, and categorical filters;
performing a semantic search on an index of a plurality of databases using the one or more columns, filter columns, and categorical filters to determine a confidence score for each database of the plurality of databases, wherein the confidence score indicates a match for each database with respect to the one or more extracted columns, filter columns, and categorical filters;
selecting a database based on the confidence score and extracting a schema of the selected database;
generating, using the LLM, a second SQL statement based on the user query and the schema;
executing the second SQL statement on the selected database to generate query results; and
presenting the query results to the user.

2. The computer-implemented method of claim 1, further comprising validating the selected database using the LLM by providing, to the LLM, a prompt that includes the user query, the schema of the selected database, and a request to determine that the selected database includes data that supports the user query.

3. The computer-implemented method of claim 1, wherein the confidence score is determined by evaluating column names of each database with respect to the one or more extracted columns or filter columns.

4. The computer-implemented method of claim 1, wherein the confidence score is determined by generating synonyms of the one or more extracted columns or filter columns, and evaluating column names of each database with respect to the generated synonyms.

5. The computer-implemented method of claim 1, wherein the confidence score is determined by evaluating the one or more extracted categorical filters with respect to categorical filters of each database.

6. The computer-implemented method of claim 1, wherein a prompt that is provided to the LLM to generate the first SQL statement or the second SQL statement includes one or more examples of desired output.

7. The computer-implemented method of claim 1, wherein a prompt that is provided to the LLM to generate the first SQL statement or the second SQL statement includes a request for the first SQL statement or the second SQL statement to comply with a particular SQL dialect.

8. A computer system comprising:
one or more memories; and
at least one processor coupled to the one or more memories, wherein the at least one processor is configured to:
generate, using a large language model (LLM), a first Structured Query Language (SQL) statement based on a user query provided by a user;
extract a plurality of entities, based on the first SQL statement, comprising one or more columns, filter columns, and categorical filters;
perform a semantic search on an index of a plurality of databases using the one or more columns, filter columns, and categorical filters to determine a confidence score for each database of the plurality of databases, wherein the confidence score indicates a match for each database with respect to the one or more extracted columns, filter columns, and categorical filters;
select a database based on the confidence score and extract a schema of the selected database;
generate, using the LLM, a second SQL statement based on the user query and the schema;
execute the second SQL statement on the selected database to generate query results; and
present the query results to the user.

9. The computer system of claim 8, wherein the at least one processor is further configured to validate the selected database using the LLM by providing, to the LLM, a prompt that includes the user query, the schema of the selected database, and a request to determine that the selected database includes data that supports the user query.

10. The computer system of claim 8, wherein the confidence score is determined by evaluating column names of each database with respect to the one or more extracted columns or filter columns.

11. The computer system of claim 8, wherein the confidence score is determined by generating synonyms of the one or more extracted columns or filter columns, and evaluating column names of each database with respect to the generated synonyms.

12. The computer system of claim 8, wherein the confidence score is determined by evaluating the one or more extracted categorical filters with respect to categorical filters of each database.

13. The computer system of claim 8, wherein a prompt that is provided to the LLM to generate the first SQL statement or the second SQL statement includes one or more examples of desired output.

14. The computer system of claim 8, wherein a prompt that is provided to the LLM to generate the first SQL statement or the second SQL statement includes a request for the first SQL statement or the second SQL statement to comply with a particular SQL dialect.

15. A computer program product, the computer program product comprising one or more computer readable storage media having program instructions collectively stored on the one or more computer readable storage media, the program instructions executable by at least one processor to cause the at least one processor to:
generate, using a large language model (LLM), a first Structured Query Language (SQL) statement based on a user query provided by a user;
extract a plurality of entities, based on the first SQL statement, comprising one or more columns, filter columns, and categorical filters;
perform a semantic search on an index of a plurality of databases using the one or more columns, filter columns, and categorical filters to determine a confidence score for each database of the plurality of databases, wherein the confidence score indicates a match for each database with respect to the one or more extracted columns, filter columns, and categorical filters;
select a database based on the confidence score and extract a schema of the selected database;
generate, using the LLM, a second SQL statement based on the user query and the schema;
execute the second SQL statement on the selected database to generate query results; and
present the query results to the user.

16. The computer program product of claim 15, wherein the program instructions further cause the at least one processor to validate the selected database using the LLM by providing, to the LLM, a prompt that includes the user query, the schema of the selected database, and a request to determine that the selected database includes data that supports the user query.

17. The computer program product of claim 15, wherein the confidence score is determined by evaluating column names of each database with respect to the one or more extracted columns or filter columns.

18. The computer program product of claim 15, wherein the confidence score is determined by generating synonyms of the one or more extracted columns or filter columns, and evaluating column names of each database with respect to the generated synonyms.

19. The computer program product of claim 15, wherein the confidence score is determined by evaluating the one or more extracted categorical filters with respect to categorical filters of each database.

20. The computer program product of claim 15, wherein a prompt that is provided to the LLM to generate the first SQL statement or the second SQL statement includes one or more examples of desired output.
